(19) United States
(12) Patent Application Publication
(10) Pub. No.: US 2016/0147824 A1
(43) Pub. Date: May 26, 2016

(54) METHOD FOR PROCESSING TIME SERIES AND SYSTEM THEREOF

(71) Applicant: INSTITUTE FOR INFORMATION INDUSTRY, TAIPEI CITY (TW)

(72) Inventors: YUNG-CHUNG KU, HSINCHU COUNTY (TW); TSUNG-JUNG TSAI, NEW TAIPEI CITY (TW); LEE-CHUNG CHEN, NEW TAIPEI CITY (TW)

(21) Appl. No.: 14/563,392

(22) Filed: Dec. 8, 2014

(30) Foreign Application Priority Data
Nov. 21, 2014 (TW) 103140555

(51) Int. Cl. G06F 17/30

(52) U.S. Cl. CPC G06F 17/30377; G06F 17/30353; G06F 17/30321; G06F 17/3048

(57) ABSTRACT

A method for processing time series is disclosed. In the method, the time series is distributed into a plurality of indexes. A statistical method is applied to the data in each index for generating corresponding statistical result. The statistical result is the value with respect to the every index, and also the record with respect to the indexes in the time series. The statistical result for the every index is temporarily buffered. After that, a new input time series is compared with the statistical result for every index so as to select one of the indexes. The new input data is therefore inserted to the selected index. The statistical method is then applied to this selected index again. A new statistical result is generated. The record is updated as referring to the selected index and the new corresponding statistical result.

### BACKGROUND

1. Technical Field

The present disclosure is generally related to a method for data processing, in particular, to the method for processing time series and a system for implementing the method.

2. Description of Related Art

In the present era of information explosion, the daily-generated data in time series is relevant to our lives. For example, the personal preference, the number of visits to a sightseeing spot, and even the information of stock prices, price index, inflation rate, interest rate, and exchange rate collected in the community network are the daily living or financial information exposed to our lives. For recognizing and employing the bid data in time series, the data can be indexed, searched, and processed in order to gain the statistics. It is important that the statistics appearing the relevant searching result or trend may aim at the purpose of commercial strategy or financial transaction.

When the data in time series is fully processed by a traditional approach, such as employing a statistical method using traditional database, it will unrealistically slow down the efficiency. The traditional statistical method fails to meet the tendency in the present era when the big data consumes the processing time.

### SUMMARY

In the disclosure, a method for processing time series in accordance with the present disclosure, and a system are provided. In the method, the data in time series is firstly distributed to a plurality of indexes. A statistical method is then applied to the data in the every index, and a statistical result is accordingly generated. The statistical result includes a result value with respect to the every index, and a record value with respect to the data in the corresponding time series. Next, the statistical result with respect to the every index is temporarily cached. After that, the value of new input data in the time series is compared with the statistical result with respect to the every index. The comparison results in selecting one of indexes. The new input data is inserted to the selected index. The statistical method is again applied to the selected index for generating new result value. The record value in a selected index is updated according the result value of the selected index.

The disclosure is related to a system for processing time series. The system includes a data distribution processing module and a data query processing module. The data distribution processing module has a data buffer and a dispenser. The data query processing module has a selector and an analyzer. The data query processing module is coupled to the data distribution processing module. The dispenser is coupled to the data buffer. The analyzer is coupled to the selector. The data distribution processing module is used to receive the data in the time series and distribute the data into a plurality of indexes. The statistical method is applied to the every index. The data buffer is used to cache the statistical result with respect to the every index. The statistical result includes the result value with respect to the every index, and the record value with respect to the data in the time series. The dispenser is used to compare the new input data in the time series and the statistical result for every index, and accordingly select one of the indexes. The new input data is therefore inserted into the selected index. The statistical method is again applied to the selected index for generating a new result value. The selector is use to select one of the indexes. The analyzer is used to update the record value using the result value of the selected index.

In summation, the method and system for processing the time series in the disclosure provide fast result probably with low accuracy when the system focuses on making decision with tendency. More details, the method provides an approach to process the bid data with distributed process as considering the distributed indexed error balance. The method provides a result with quite accuracy and predictable response time under a normal distribution model. It is worth noting that the method is able to maintain a stable response time when a sampling scheme is applied to the distributed indexed data for ensuring the computation load.

In brief, the method and system in accordance with the present disclosure can keep the efficiency of sampling in groups, accuracy of sampling, and a stable response time.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

FIG. 1 shows a schematic diagram of the system for processing time series in one embodiment in accordance with the present disclosure;

FIG. 2 shows a flow chart depicting the method for processing time series in one embodiment of the present disclosure;

FIG. 3 shows a flow chart depicting computation of statistical average in the time series in one embodiment of the method;

FIG. 4 shows a schematic diagram depicting the data distribution processing module is the system distributing time series into a plurality of indexes in one embodiment of the present disclosure;

FIG. 5 shows a flow chart depicting the method for processing time series in variance calculation in one embodiment of the present disclosure;

FIG. 6 is a schematic diagram depicting the data distribution processing module distributing time series in variance calculation in one embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

According to the embodiments in the disclosure, one of the objectives thereof is to distribute the data in time series into a plurality of indexes, and perform statistical method onto the every index. Next, new input data in the time series is compared with the value in the every index. The new input data may be accordingly inserted to one selected index. The distribution scheme in the present method provides fast and accurate computation for keeping a normal distribution model as considering the distributed indexed error balance. Followings are the details of the embodiment.

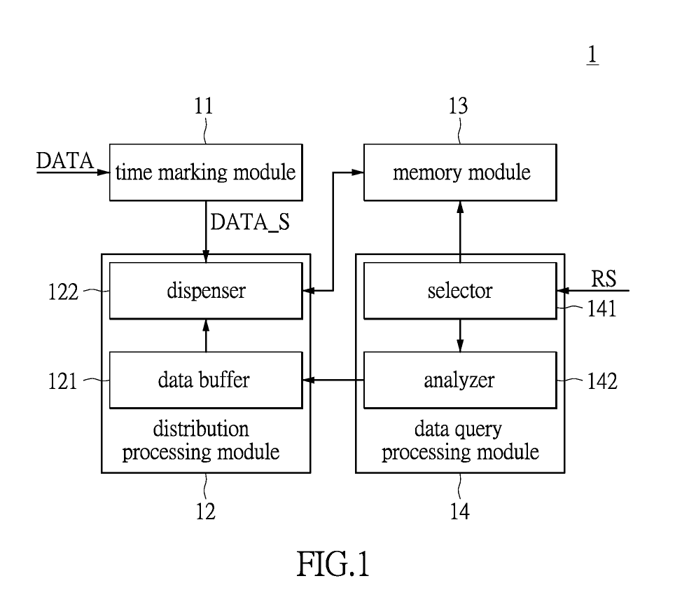

Reference is made to FIG. 1 showing a schematic diagram of the system for processing time series in one embodiment of the present disclosure.

A system 1 for processing time series includes a time marking module 11, a data distribution processing module 12, a memory module 13, and a data query processing module 14. The data distribution processing module 12 includes a data buffer 121 and a dispenser 122. The data query processing module 14 includes a selector 141 and an analyzer 142. The relationship appears that the data distribution processing module 12 is coupled to the time marking module 11; the memory module 13 is coupled to the data distribution processing module 12; the data query processing module 14 is coupled to the memory module 13 and the data distribution processing module 12; the data buffer 121 is coupled to the dispenser 122; and the analyzer 142 is coupled to the selector 141.

The time marking module 11 exemplarily includes the suitable circuits, logics, and/or codes. The time marking module 11 is used to mark time stamp onto the data in time series for generating the time series DATA_S. The time series DATA_S indicates the kinds of activities composed of distributed events.

According to one of the embodiments, the data distribution processing module 12 is used to receive the data in time series DATA_S, and distribute the data into a plurality of indexes. A statistical method is applied to the every index and correspondingly generating statistical results. The statistical result includes the result value with respect to the every index and the record value with respect to the data in time series DATA_S. It is noted that, the statistical method provided by the data distribution processing module 12 is an average calculation or a variance calculation. The result value is as well an average value or a variance value. More details, the average calculation is to compute an average of summation of the values of data or sampled data in the index. The variance calculation is used to make substitution of the new input data in the time series DATA_S and the data in the data list. In which, a static number of data in the index is sampled to create a data list; an insertion sort algorithm is used to sort the static number of data in the data list according to their size.

Furthermore, the data buffer 121 of the data distribution processing module 12 includes suitable circuits, logics and/or codes for caching the statistical result with respect to the every index. The statistical result includes result value with respect to the every index, and record value with respect to the data in the time series DATA_S. In other words, the data buffer 121 renders a cache such as statistics cache for the data distribution processing module 12 to cache the statistical result for every index.

The dispenser 122 of the data distribution processing module 12 also includes suitable circuits, logics, and/or codes. The dispenser 122 is used to compare the new input data received by the data distribution processing module 12 and the statistical result with respect to the every index. Accordingly, one of the indexes is selected. After that, the dispenser 122 inserts the new input data to the selected index for re-generating result value as applying the statistical method to the selected index.

For example, when the statistical method performed by the data distribution processing module 12 is an average calculation, the result value with respect to the every index is an average value for all data for each index. In the meantime, the dispenser 122 inserts the new input data to the index with minimum average value among the indexes when the value of new input data in the time series DATA_S is larger than the record value. Further, the dispenser 122 inserts the new input data to the index with maximum average value among the indexes when the value of new input data in the time series DATA_S is smaller than the record value. When the new input data is inserted to the index, the average values are summed. The record value is an average of the values for the every index. On the other hand, the record value may represent the average for all data in the time series DATA_S.

In an exemplary example, the result value with respect to every index is a variance value in the data list for the every index when the statistical method performed by the data distribution processing module 12 is a variance calculation. The dispenser 122 replaces the maximum of values smaller than the value of new input data in the data list of the selected index with the value when the value of new input data in the time series DATA_S is larger than the variance value.

The dispenser 122 replaces the minimum of values larger than the new input data in the data list of the selected index with the value when the value of new input data is smaller than the variance value. It is noted that the variance value is the value closest to the average of static number of data. The record value may be the average variance value with respect to every index.

It is worth noting that, both the average calculation and the variance calculation may be performed simultaneously even though the average calculation and the variance calculation are separately mentioned and implemented. More details, when the dispenser 122 compares the value of new input data in the time series DATA_S with the record value, the new input data is inserted to one of the indexes according to the average value for every index. In the meantime, the dispenser 122 samples a static number of data in the selected index for creating a data list. Then the static number of data in the data list is sorted according to their sizes. The dispenser 122 compares value of the new input data in the time series DATA_S with the variance value, and accordingly updates the record value as replacing the value in the data list.

The memory module 13 includes suitable circuits, logics, and/or codes. The memory module 13 is used to store the data distributed over the indexes in the time series DATA_S. More details, when the data in the time series DATA_S is distributed by the data distribution processing module 12, the data is stored in the memory module 13.

The selector 141 of the data query processing module 14 includes suitable circuits, logics and/or codes. The selector 141 is used to select one of indexes. More details, the selector 141 may be used to receive a query RS for randomly selecting one of the indexes. Then a user may search the big data in time series in the memory module 13 through the query RS. The query command allows the user to have tendency of behavior characteristics.

The method in the present disclosure may provide an approach to query the tendency rather than precisely get the data. The query RS received by the selector 141 includes information of time granularity. It is noted that, when the time granularity is smaller than a pre-defined range, the data in the selected index within the pre-defined range is operated. In other words, the accurate computation could be done even the time granularity is smaller. It is noted that the pre-defined range may be configured based on experience of a user or an operator.

The analyzer 142 of the data query processing module 14 includes suitable circuits, logics and/or codes. The analyzer 142 is used to update the record value according to the result value of the selected index. More details, when the data distribution processing module 12 distributes the new input data in the time series DATA_S and generates a new result value, the record value in the data buffer 121 is not updated until the selector 141 receives the query command at the next time. When the selector 141 receives query RS, the record value in the data buffer 121 can be updated by the analyzer 142 as reading out the statistical result for every index from the memory module 13. The above depiction may not limit the scope of the present disclosure. In practice, the record value in the data buffer 121 can also be updated when the data distribution processing module 12 has distributed the new input data and computed a new result value.

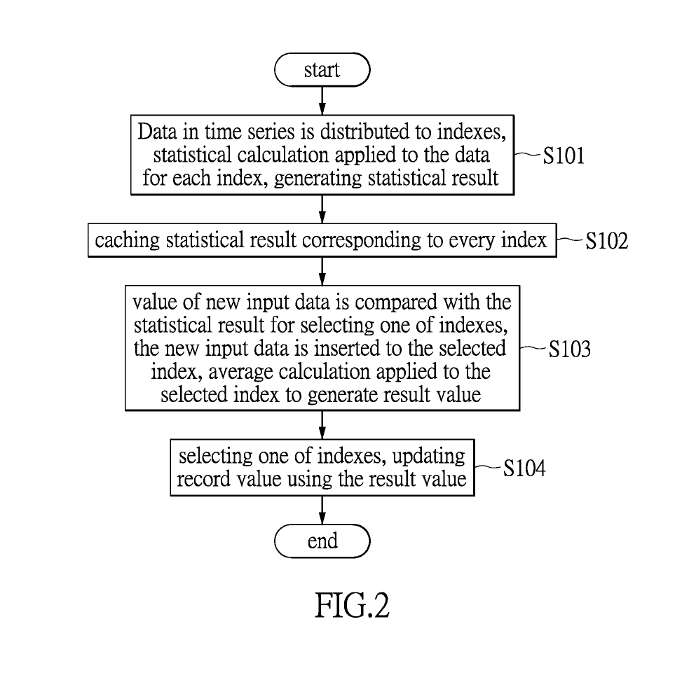

The next description is related to the method for processing time series. Reference is made to FIG. 2.

In the method for processing time series, such as in step S101, the data in the time series is distributed into a plurality of indexes. A statistical method is applied to the data for every index for generating a corresponding statistical result. Next, in step S102, the statistical result for every index is temporarily cached. In step S103, the value of new input data in the time series is compared with the statistical result for the every index. According to the result of comparison, one of the indexes is selected, and the new input data is inserted to the selected index. A new result value can be generated as applying an average calculation to the selected index. In step S104, one of the indexes is selected, and the record value is updated using the result value for the selected index.

Reference is made to both FIG. 1 and FIG. 2. In step S101, the data distribution processing module 12 is used to receive data in the time series DATA_S. The data is distributed to a plurality of indexes for generating statistical result as applying a statistical method to each index.

In step S102, the data buffer 121 is used to cache the statistical result for every index. That means the data buffer 121 renders a statistics cache for the data distribution processing module 12 to cache the statistical result for every index and record value of the data in time series.

In step S103, the dispenser 122 compares the value of new input data received by the data distribution processing module 12 with the statistical result with respect to every index, and accordingly selects one of the indexes. After that, the dispenser 122 inserts the new input data to the selected index. A new result value is generated as again applying the statistical method to the selected index.

In step S104, when a user inputs query RS to the selector 141, the result value of one of the indexes in the memory module 13 is randomly or orderly selected. The selector 141 transmits the result value selected by the query RS to the analyzer 142. The analyzer 142 then updates record value in the data buffer 121 using the result value for the selected index.

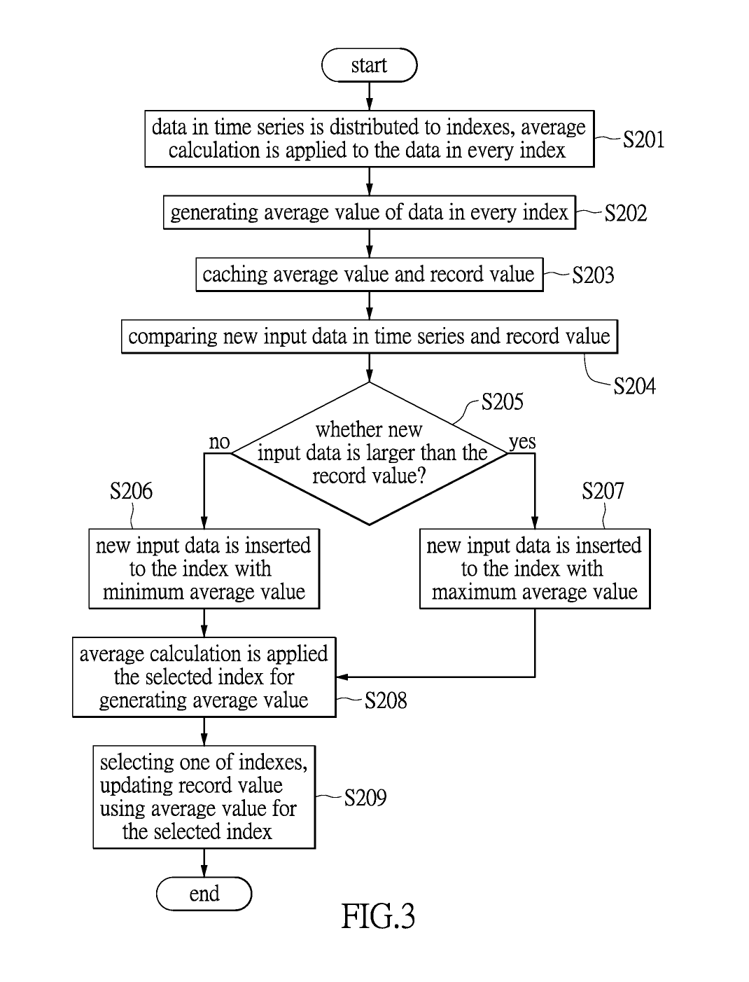

Reference is made to FIG. 3. The shown flow chart describes the average calculation of the statistical method in the method for processing time series.

In step S201, the data in time series is distributed into a plurality of indexes. An average calculation is performed to the data in every index. In step S202, an average value for all data in every corresponding index is generated. In step S203, the average value and the record value are temporarily cached. In step S204, the new input data in the time series is compared with the record value. In step S205, it is determined if the value of new input data is larger than the record value. In step S206, the new input data is inserted to the index with minimum average value. In step S207, the new input data is inserted to the index with maximum average value among the indexes. In step S208, an average value is generated when an average calculation is performed to the selected index. In step S209, one of the indexes is selected, and the record value is updated using the average value for the selected index.

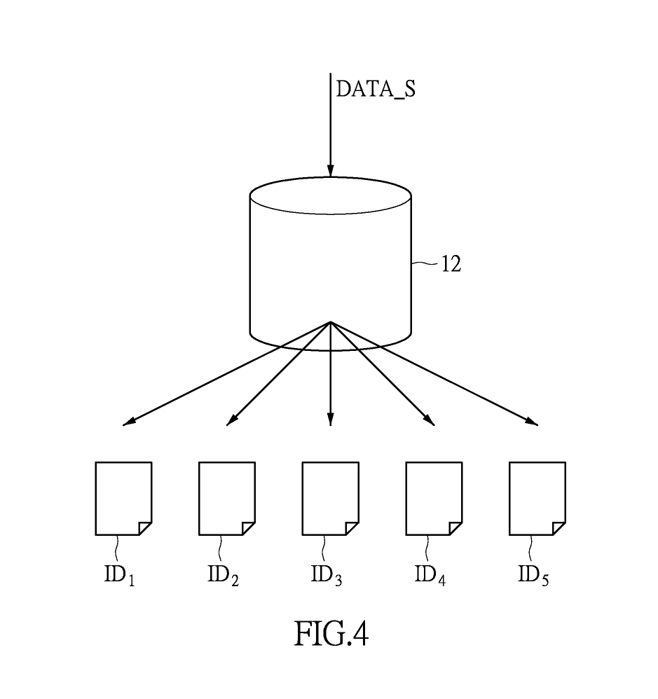

Reference is made to all of FIG. 1, FIG. 3, and FIG. 4. In FIG. 4, the data in time series distributed into a plurality of indexes made by the data distribution processing module is depicted. In step S201, the data distribution processing module 12 is used to receive the data in the time series DATA_S. In which, the dispenser 122 is employed to distribute the data into five indexes, namely the indexes ID₁-ID₅. Next, in step S202, the dispenser 122 performs an average calculation onto every index (ID₁-ID₅). The every average value with respect to every index (ID₁-ID₅) is obtained. Further, the average value is such an average of sum of all the data or sampled data in all indexes ID₁-ID₅. For example, the average values for the indexes ID₁-ID₅ are sorted in size as ID₅>ID₄>ID₃>ID₂>ID₁.

In step S203, the data buffer 121 caches the average values of [symbol] the indexes ID₁-ID₅. It is noted that the data buffer 121 may store an average of all the average values in addition to storing the every average value with respect to every index ID₁-ID₅. The average of all the average values is such as the record value mentioned above.

In step S204, the dispenser 122 is used to compare the new input data in the time series DATA_S received by the data distribution processing module 12 with the record value. According to the result of comparison, one of the indexes ID₁-ID₅ is selected.

Following the step S204, such as in step S205, the dispenser 122 determines whether or not the value of the new input data in the time series DATA_S is larger than the record value which is the average of all the average values of the indexes ID₁-ID₅. If the value of new input data is larger than the record value, the method goes on step S207. If the value of new input data is smaller than the record value, the method enters step S206.

More details, the new input data is inserted to the index (ID₁ exemplified in this example) with minimum average value among the indexes ID₁-ID₅ when the dispenser 122 determines that the value of new input data is larger than the record value that steps in step S207. On the other hand, the new input data is inserted to the index (ID₅ exemplified in this example) with maximum average value among the indexes ID₁-ID₅ when the dispenser 122 determines that the value of new input data is smaller than the record value that steps in step S206. Furthermore, in order to balance error among the indexes ID₁-ID₅, the dispenser 122 is able to select one of the indexes ID₁-ID₅ to be inserted with the new input data according to the average value with respect to the index ID₁-ID₅.

Next, in step S208, the dispenser 122 again performs an average calculation onto the selected index ID₁ or ID₅ inserting the new input data for gaining new average value. It is noted that the index ID₁ is selected since the value of new input data is larger, and the ID₅ is selected since the value of new input data is smaller.

At last, in step S209, when the selector 141 receives a user's query RS, the selector 141 randomly or orderly selects an average value of the one of the indexes ID₁-ID₅ stored in the memory module 13. Next, the selector 141 further transmits the selected average value in response to the query RS to the analyzer 142. The analyzer 142 then updates the record value in the data buffer 121 using the average value of the selected index ID₁ or ID₅.

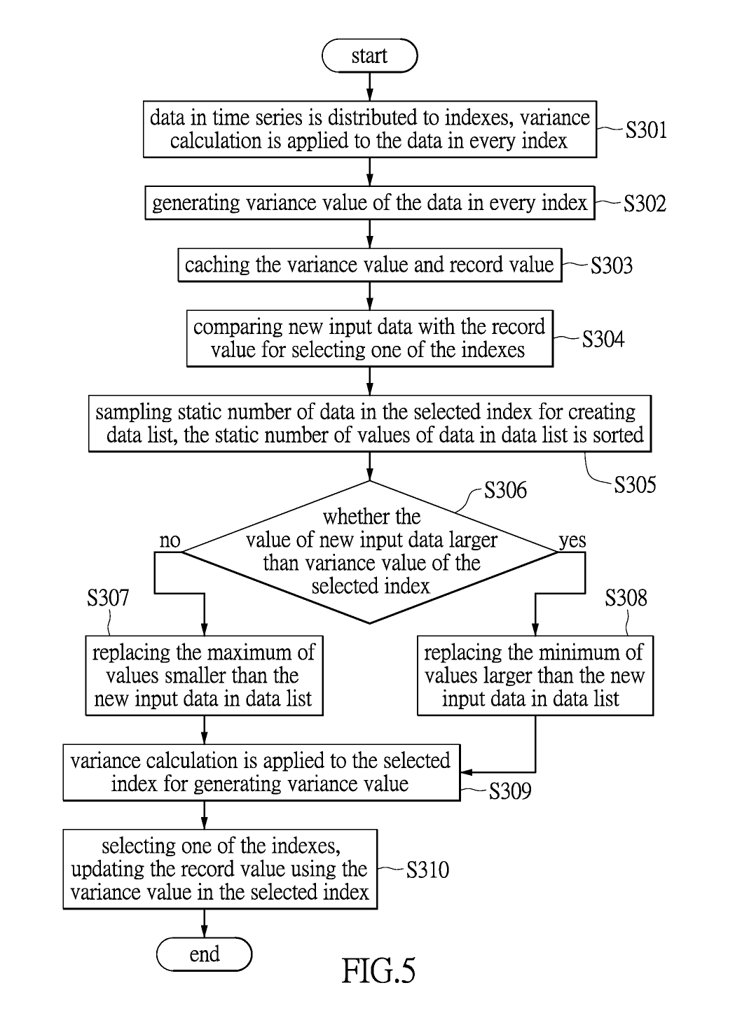

Next, reference is made to FIG. 5 showing a flow chart exemplarily depicting the variance calculation in the method of the present disclosure.

The method in the variance calculation in one embodiment includes the following steps. In step S301, the data in time series is distributed to a plurality of indexes. The variance calculation is applied to the data with respect to the index. In step S302, a variance value for the every index is obtained. In step S303, the variance value and the record value are cached. In step S304, the value of new input data in time series is compared with the record value, and accordingly one of the indexes is selected. In step S305, a static number of data in the selected index is sampled for creating a data list. The static number of data in the data list is sorted in size, for example through an insertion sort algorithm. In step S306, it is determined that if the value of the new input data is larger than the variance value of the selected index. In step S307, the maximum of values smaller than the value of new input data in the data list is replaced with the value of new input data. In step S308, the minimum of values larger than the value of new input data in the data list is replaced with the value of new input data. In step S309, a variance calculation is again applied to the selected index for generating variance value. In step S310, the record value is updated using the variance value in the selected index.

Reference is again made to FIG. 1, FIG. 4, and FIG. 5. The aforementioned steps S301-S303 and S306 are similar with the steps S201-204, and the difference there-between exists because the two different calculations are employed. It is noted that the step S304 includes the step to insert the new input data in the selected index described in step S204-S207. Further, in other embodiment, the step described in S304 may be, but not limited to, implemented with the random or orderly selection.

In step S305, the dispenser 122 further creates a data list for the static number of sampled data in the selected index. Further, the values of the static number of data in the data list are stored according to their sizes.

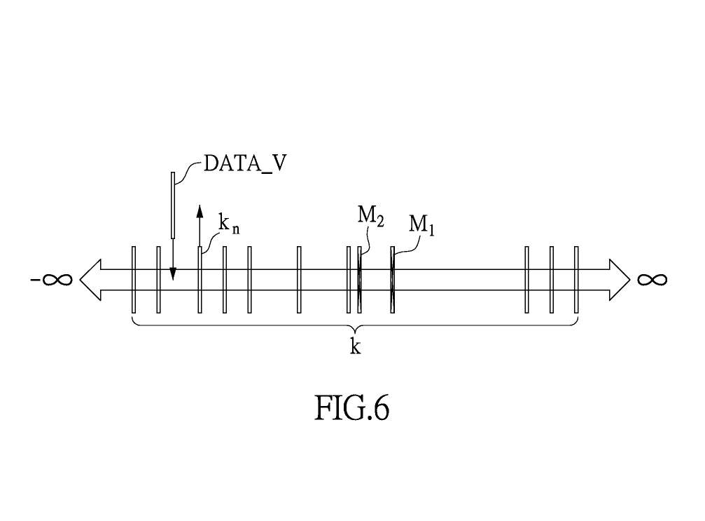

Reference is made to FIGS. 1, 5 and 6. FIG. 6 schematically shows the data distribution processing module distributes the data in time series with variance calculation. In which, the dispenser 122 samples a certain number of data, e.g. ‘k’, for purpose of sorting and creating a data list. Next, in step S306 in view of FIG. 6, when the new input data DATA_V is inserted to the selected index, it is determined that if the value of the new input data is larger than the variance value M₁ of the selected index. If the value of new input data is larger than the value M₁, the steps go on the step S307; conversely, the steps go no step S308.

More details, the steps are proceeding step S307 when the dispenser 122 ascertains the value of new input data DATA_V in the time series DATA_S is larger than the variance value M₁ of the selected index. In the selected index, the maximum of the values smaller than the new input data DATA_V in the data list is replaced with the value of new input data. On the contrary, the steps are proceeding step S308 when the dispenser 122 ascertains the value of new input data DATA_V in the time series DATA_S is smaller than the variance value M₁. At this moment, in the selected index, the minimum of values larger than the new input data DATA_V in the data list is replaced with the value of new input data. For example, in step 6, the value kₙ is replaced with the value of new input data DATA_V.

Next, in step S309, the dispenser 122 re-generates the variance value by performing variance calculation upon the selected index with the new input data. For example, referring to FIG. 6, the new variance value M₂ is re-generated when the new input data DATA_S is smaller than the previous variance value M₁.

At last, in step S310, the user inputs query RS to the selector 141 so as to randomly or orderly select the variance value in one of indexes stored in the memory module 13. The selector 141 transmits the variance value M₂ selected by the instruction query RS to the analyzer 142. The analyzer 142 then updates the record value in the data buffer 121 using the variance value of the selected index.

In summation, the method for process time series and the system for the same are provided. The system may quickly render a calculation result with acceptable accuracy in the decision-making situations circumstance as paying attention to tendency. More details, when the big data is distributed as considering distributed indexed error balance, the system can provide accurate calculation result with predictable response time in compliance with a normal distribution model. It is noted that the system employs scheme to sample the distributed indexed data for ensuring a computation load, and maintaining a stable response time.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A method for processing time series, comprising:
step A: distributing the time series into a plurality of indexes, a statistical method is applied to the data with respect to every index so as to generate a corresponding statistical result, wherein the statistical result includes a value with respect to every index and a record of the time series;
step B: caching the statistical result for every index;
step C: comparing a new input time series with the statistical result with respect to every index, and accordingly selecting one of the indexes and inserting the new input data to the selected index, so as to re-generate the statistical result for the selected index as applying the statistical method; and
step D: updating the record as referring to the selected index and the corresponding statistical result.

2. The method of claim 1, wherein, in the step A, the statistical method is for statistical average or variance, and the statistical result is an average value or a variance value.

3. The method of claim 2, wherein, in the step C, the statistical result for the every index is the average value of data of the index when the statistical method is for statistical average; the new input data is inserted to the index with minimum average value of the indexes when the value of new input data is larger than the record; and the new input data is inserted to the index with maximum average value of the indexes when the value of new input data is smaller than the record.

4. The method of claim 2, wherein, in the step C, further sampling a static number of data in the selected index for generating a data list; wherein the data list records the static number of values being sorted according to size.

5. The method of claim 4, wherein, in the step C, the statistical result for the every index is the variance of the data list for the index when the statistical method is for statistical variance; the new input data is inserted into the data list with insertion sort algorithm.

6. The method of claim 5, wherein the variance of the data is closest to variance of the data list.

7. The method of claim 1, wherein, in the step D, randomly selecting one of the indexes in response to a query, wherein the query includes information relating a time granularity; when the time granularity is smaller than a pre-defined range, the data of the selected index within the pre-defined range is operated.

8. A system for processing time series, comprising:
a data distribution processing module, used to receive a time series, and distribute the data into a plurality of indexes, allowing a statistical method applied to the every index, wherein the data distribution processing module comprises:
a data buffer, used to cache a statistical result with respect to the every index, wherein the statistical result includes a result value corresponding to the every index and a record value corresponding to the time series; and
a dispenser, coupled to the data buffer, used to compare a new input time series with the statistical result with respect to the every index, so as to select one of the indexes and insert the new input data to the selected index; wherein the statistical method is applied to the selected index for re-generating result value; and
a data query processing module, coupled to the data distribution processing module, comprising a selector used to select one of the indexes; and an analyzer, coupled to the selector, used to update the record value using the result value of the selected index.

9. The system of claim 8, wherein the statistical method used in the data distribution processing module is an average calculation or a variance calculation; and the result value is an average value or a variance value.

10. The system of claim 9, wherein, when the statistical method is for statistical average, the result value with respect to the every index is the average value of data in all indexes; when the dispenser inserts the new input data to the index with minimum average value among the indexes when the value of new input data is larger than the record value; and insert the new input data to the index with maximum average value among the indexes when the value of new input data is smaller than the record value.

11. The system of claim 9, wherein the analyzer generates a data list using a static number of data sampled from the selected index, and sorts the values of the static number of data in the data list according to size.

12. The system of claim 11, wherein, when the statistical method is for statistical variance, the result value respect to the every index is the statistical variance of the data list in the every index; the dispenser replaces the maximum of values smaller than the new input data in the data list with the value when the value of new input data is larger than the record value of the selected index; replaces the minimum of the values larger the new input data in the data list with the value when the value of new input data is smaller than the record value of the selected index.

13. The system of claim 12, wherein the statistical variance is the value of data closest to the variance value of the static number of data.

14. The system of claim 8, wherein the selector receives a query for randomly selecting one of the indexes, and the received query includes information of a time granularity.

15. The system of claim 14, wherein the analyzer operates the data of the selected index within the pre-defined range when the time granularity is smaller than a pre-defined range.

16. The system of claim 8, further comprising:
a memory module, coupled to the data distribution processing module and the data query processing module, used to store the time series distributed to the indexes.

17. The system of claim 8, further comprising:
a time marking module, coupled to the data distribution processing module, used to mark the data in time series with time stamps so as to generate the time series.
